(19) United States
(12) Patent Application Publication
(10) Pub. No.: US 2015/0244207 A1
(43) Pub. Date: Aug. 27, 2015

(54) DC/DC CONVERTER, METHOD OF CONTROLLING THE DC/DC CONVERTER AND DATA STORAGE APPARATUS

(71) Applicant: Kabushiki Kaisha Toshiba, Tokyo (JP)

(72) Inventor: Teruyuki Narita, Machida-shi (JP)

(73) Assignee: Kabushiki Kaisha Toshiba

(21) Appl. No.: 14/315,755

(22) Filed: Jun. 26, 2014

Related U.S. Application Data
(60) Provisional application No. 61/945,635, filed on Feb. 27, 2014.

(51) Int. Cl. H02J 9/06; H02M 3/04; H02M 1/36

(52) U.S. Cl. CPC H02J 9/061; H02M 1/36; H02M 3/04

(57) ABSTRACT

According to one embodiment, a DC/DC converter is supplied with a DC power supply voltage from a main power supply, or a backup voltage from a backup power supply, converts the DC power supply voltage to a DC conversion voltage or converts the backup voltage to a backup conversion voltage, and supplies the DC conversion voltage or the backup conversion voltage to a load. The converter includes a stop function for stopping the conversion operation of the DC power supply voltage in the converter part when the DC power supply voltage has lowered to less than a certain threshold voltage. This stop function is disabled when a backup power is supplied, and the converter continues the conversion operation of the backup voltage.

### CROSS-REFERENCE TO RELATED APPLICATIONS

This application claims the benefit of U.S. Provisional Application No. 61/945,635, filed Feb. 27, 2014, the entire contents of which are incorporated herein by reference.

### FIELD

Embodiments described herein relate generally to a DC/DC converter, a method of controlling the DC/DC converter and a data storage apparatus

### BACKGROUND

A DC/DC converter is provided in various kinds of electronic apparatuses, for example, a hard disk apparatus or a magnetic disk apparatus (hereinafter, simply referred to as “HDD”), and supplies power to a control circuit of the HDD by stepping down a voltage from a main power supply which supplies power to the HDD. In the HDD, a circuit for realizing a PLP (Power Loss Protection) function is added onto the circuit board on which the DC/DC converter is mounted, and this PLP function prepares for power shutoff from the main power supply. This PLP function is a function of providing power supply backup, even when a sudden power supply shutoff or voltage decrease has occurred in a state in which buffer data in a volatile memory is being held. By this PLP function, data, which is saved in a volatile memory, can be stored in a nonvolatile memory by power supplied from a backup power supply, for example, a large-capacity capacitor, and data loss based on power supply shutoff, etc. can be prevented.

In addition, the DC/DC converter includes a UVLO (Under Voltage Protecting function) function for effecting protection against a voltage decrease of the main power supply, and a current limit function: also called over-current protection function for effecting protection against incoming of over-current.

In a step-down DC/DC converter including the UVLO function and current limiting function, an input voltage or current of the DC/DC converter is monitored. When the monitored input voltage or current has exceeded a UVLO detection voltage or an OCP setup value (threshold), the DC/DC converter is protected, the output voltage or current of the DC/DC converter is shut off, and a rated output current of the DC/DC converter is safely and stably output.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram which schematically illustrates a circuit configuration of a voltage supply circuit which includes a step-down DC/DC converter according to an embodiment and supplies power to a peripheral circuit of an HDD.

FIG. 2A is a waveform chart illustrating, as a comparative example, an input voltage Vin and an output voltage Vout of the DC/DC converter shown in FIG. 1 at a time when UVLO is turned on and the UVLO functions.

FIG. 2B is a waveform chart illustrating an input voltage Vin and an output voltage Vout of the DC/DC converter shown in FIG. 1, in an embodiment in which UVLO is turned off and the UVLO does not function.

FIG. 3A is a waveform chart illustrating an example of an input voltage waveform which is input from a power supply shown in FIG. 1 to the DC/DC converter.

FIG. 3B is a waveform chart illustrating a switching operation of a first switch in a circuit which realizes a PLP (Power Loss Protection) function shown in FIG. 1.

FIG. 3C is a waveform chart illustrating a switching operation of a second switch in the circuit which realizes the PLP (Power Loss Protection) function shown in FIG. 1.

FIG. 3D is a waveform chart illustrating an output voltage from the DC/DC converter shown in FIG. 1.

FIG. 4 is a block diagram which schematically illustrates a circuit configuration of the DC/DC converter shown in FIG. 1.

FIG. 5 is a block diagram illustrating a configuration of a magnetic disk apparatus including the DC/DC converter shown in FIG. 1 and FIG. 4.

FIG. 6 is a flowchart illustrating a process which is executed in a power monitor and a processor shown in FIG. 5.

### DETAILED DESCRIPTION

Various embodiments will be described hereinafter with reference to the accompanying drawings.

A DC/DC converter according to an embodiment includes:

an input terminal to which a main DC power composed of main supply voltage and a DC supply current is to be supplied from a main power supply, or to which a backup power composed of a backup voltage and a backup current is to be supplied;

a converter part configured to convert the DC power supply voltage and the backup voltage to a DC conversion voltage and a backup conversion voltage, respectively, and to output the conversion voltage;

an output terminal from which the DC conversion voltage or the backup conversion voltage is to be output to a load; and

a first circuit part including a first stop function for stopping the conversion operation of the DC power supply voltage in the converter part when the DC power supply voltage has lowered to less than a certain threshold voltage, the first circuit part being configured to disable the first stop function in accordance with supply of the backup power, and to cause the converter part to continue the conversion operation of the backup voltage.

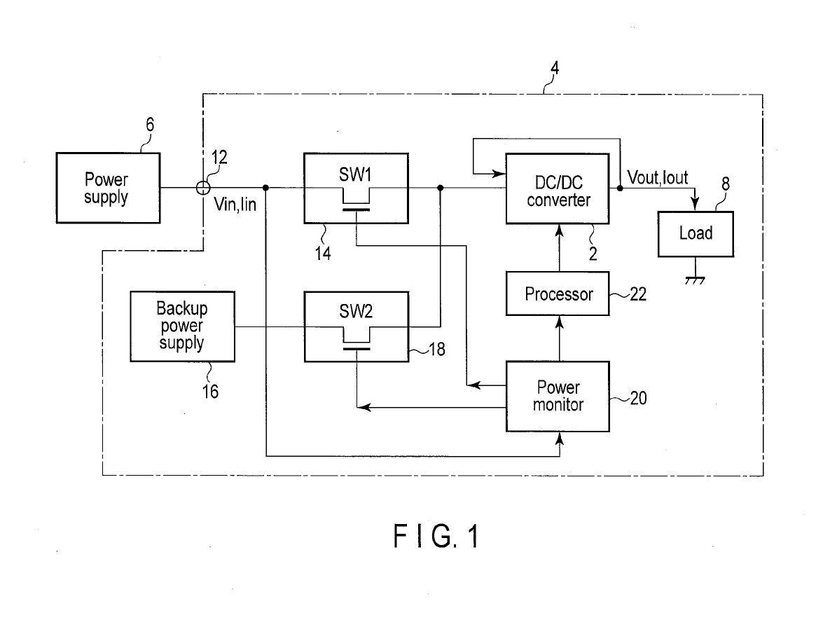

FIG. 1 illustrates a DC voltage supply circuit including a DC/DC converter 2 according to an embodiment. This DC voltage supply circuit is mounted on a printed circuit board (PCB) 4 for a hard disk drive (HDD), and is connectable to an external main power supply 6 outside this PCB 4. From the DC/DC converter 2, a power including an output voltage Vout and an output current Iout is supplied to a load (Load) 8, for example, a control circuit of the HDD. In this case, the control circuit as the load (Load) 8 includes a volatile memory 8 (SDRAM (synchronous DRAM), SRAM), a processor, or a driver IC for driving a mechanical part.

Although FIG. 1 depicts a circuit configuration in which a single DC/DC converter 2 supplies power to a single load 8, such a configuration may be adopted that different voltages (V1 to Vn) and currents (I1 to In) are supplied to a plurality of loads 8. In this circuit configuration, each of a plurality of voltage supply circuits may include a DC/DC converter 2, and these plural voltage supply circuits may be connected to different loads respectively.

The external main power supply 6 is connected, via a power port 12 of the PCB 4, to a first switching element 14 which is connected to the DC/DC converter 2. At a normal mode time during the operation of the HDD, the external main power supply 6 supplies an input voltage Vin and an input current Iin to an input side of the DC/DC converter 2 via the first switching element 14. The DC/DC converter 2 steps down the input voltage Vin, and outputs, at the output side thereof, an output voltage Vout and an output current Iout. As will be described later in detail, the output voltage Vout and output current Iout are fed back to an output control circuit on the input side of the DC/DC converter 2, and are stabilized.

The voltage supply circuit shown in FIG. 1 includes a PLP (Power Loss Protection) function in preparation for power supply shutoff from the main power supply 6 or a sudden power decrease. Specifically, the voltage supply circuit according to the embodiment includes a backup power supply 16 so as to supply power to the load 8 even when sudden power supply shutoff or a sudden power decrease (power loss due to a sudden decrease in input voltage or input current) has occurred during a data process and a fault or abnormality has occurred in the power supply from the external main power supply 6. In the voltage supply circuit, power supply abnormality of the main power supply 6 is detected by a power monitor 20. In an SSD (Solid State Drive), this backup power supply 16 may be a large-capacity capacitor, for example, an electric double-layer capacitor (Super Capacitor) or an electrically conductive tantalum polymer solid electrolytic capacitor (POSCAP (trademark)), and electric charge energy accumulated in a large-capacity capacitor is utilized as a backup power supply. In addition, in an HDD, the backup power supply 16 may be a power supply part which uses of regenerative energy as a back electromotive force (BEMF) which occurs when a spindle motor (SPM) for rotating a disk stops. The backup power supply 16 is connected to an input side of the DC/DC converter 2 via a second switching element 18, and supplies an auxiliary input voltage Vin and an auxiliary input current Iin via the second switching element 18 at a time of power lowering of the main power supply 6 or at a time of a fault or abnormality such as power shutoff of the main power supply 6 (hereinafter, simply referred to as “fault mode time”).

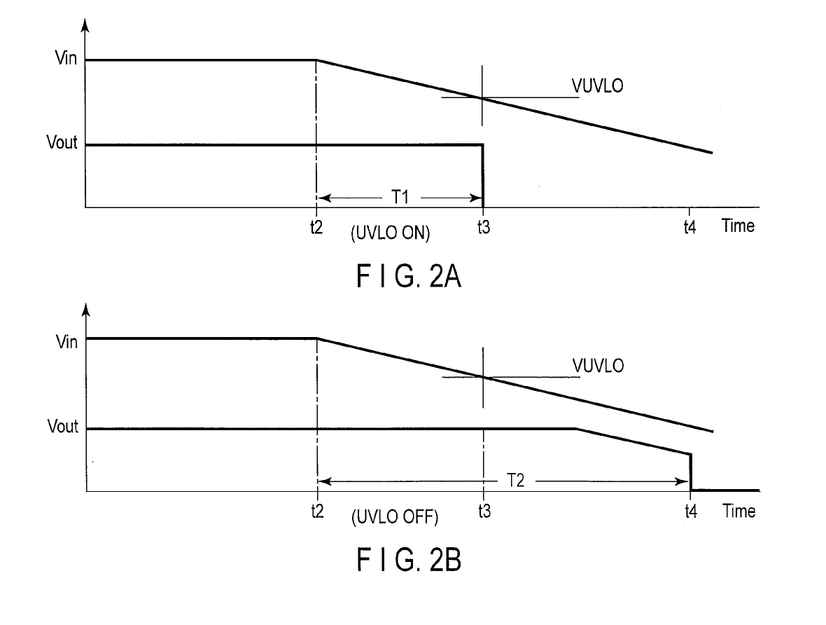

In addition, the DC/DC converter 2 shown in FIG. 1 includes a UVLO (Under Voltage Lock Out) function for protecting the converter against an increase of supply current based on a decrease of voltage from the main power supply 6, and a current limit function (also referred to as OCP function: Over Current Protection function) for protecting the converter against the supply of over-current from the main power supply 6, and prevents electric breakdown of the DC/DC converter 2. The DC/DC converter 2 converts an input power (input voltage×input current) to an output power (output voltage×output current). Since the DC/DC converter 2 executes control to keep the output voltage constant, (1) if the input voltage is constant and the output voltage increases, the input current increases, and (2) if the output current is constant and the input voltage decreases, the input current increases. There is a concern that an input power exceeding a rated power, that is, an increase in input current, causes electric breakdown of the DC/DC converter. Thus, in the DC/DC converter 2, the input voltage and input current are monitored by the UVLO function and OCP function, and the circuit is protected so as not to exceed the rated input power. In a case of an operation in which the input current Iin exceeds a certain threshold Iocp, the OCP function operates and the operation of the DC/DC converter 2 is stopped in order to protect the DC/DC converter 2. In addition, in a case of an operation in which the input voltage lowers to a certain threshold voltage Vuvlo and the input current increases, despite the output voltage being substantially constant, the UVLO function also operates in order to protect the DC/DC converter 2, and the operation of the DC/DC converter 2 is stopped. If sudden power supply shutoff or a sudden power decrease (sudden decrease in input voltage and input current) occurs in the main power supply and the PLP function operates, and switching occurs from the main power supply to an auxiliary power supply (backup power supply), the UVLO function and OCP function are rendered off after unnecessary circuits are shut off. Since the power consumption is reduced by the shutoff of unnecessary circuits, the input power to the DC/DC converter 2 can be suppressed, and the operation period of the DC/DC converter 2 can be extended by using the limited power of the backup power supply. To be more specific, as illustrated in FIG. 2A as a comparative example, even after the switching to the auxiliary power supply, if the voltage from the auxiliary power supply gradually decreases from a timing t2, a certain threshold voltage Vuvlo is detected and the UVLO function operates. At a timing t3, the supply of an output voltage Vout, which is generated from the auxiliary power supply, is stopped. Accordingly, even if the PLP (Power Loss Protection) function operates to effect switching from the main power supply to the auxiliary power supply, the supply of the output voltage Vout, which is generated from the auxiliary power supply in a period T1 between timings t2 to t3, is stopped, despite the supply of power from the auxiliary power supply being possible. By contrast, in the DC/DC converter 2 of the embodiment, if the PLP (Power Loss Protection) function operates to effect switching from the main power supply to the auxiliary power supply, and the backup power begins to be supplied, the UVLO and OCP functions are disabled by an instruction from the processor 22. Accordingly, as illustrated in FIG. 2B, at the timing t3, even if the threshold voltage Vuvlo is detected, the UVLO function does not operate, and the output of the DC/DC converter 2 is continued. Specifically, the DC/DC converter 2 operates and the output voltage Vout is supplied, until a timing t4 when a certain voltage, at which the operation of the DC/DC converter 2 is disabled, is reached. As is clear from the comparison between FIG. 2A and FIG. 2B, when the PLP (Power Loss Protection) function operates, the UVLO and OCP functions are disabled, and thereby the operation of the DC/DC converter 2 is ensured over a relatively long period T2 of timings t2-t4, compared to the period T1 of timings t2-t3.

In the case where the PLP (Power Loss Protection) function operates and power is supplied from the auxiliary power supply, the auxiliary power supply, unlike the main power supply, functions as a backup. The power supply of the backup power supply is limited and, in order to effectively use the power of the backup power supply, unnecessary circuits are shut off, and the current consumed by the load is decreased. Accordingly, since the output current is suppressed, there is no possibility of causing (1) a situation in which, despite the input voltage being constant, the output current increases and the input current increase, or (2) a situation in which, despite the output current being constant, the input voltage decreases, the input current increases and a tolerable current value is exceeded. Therefore, even if the UVLO function and OCP function of the DC/DC converter 2 are disabled, there is no possibility that the DC/DC converter 2 is damaged by over-current.

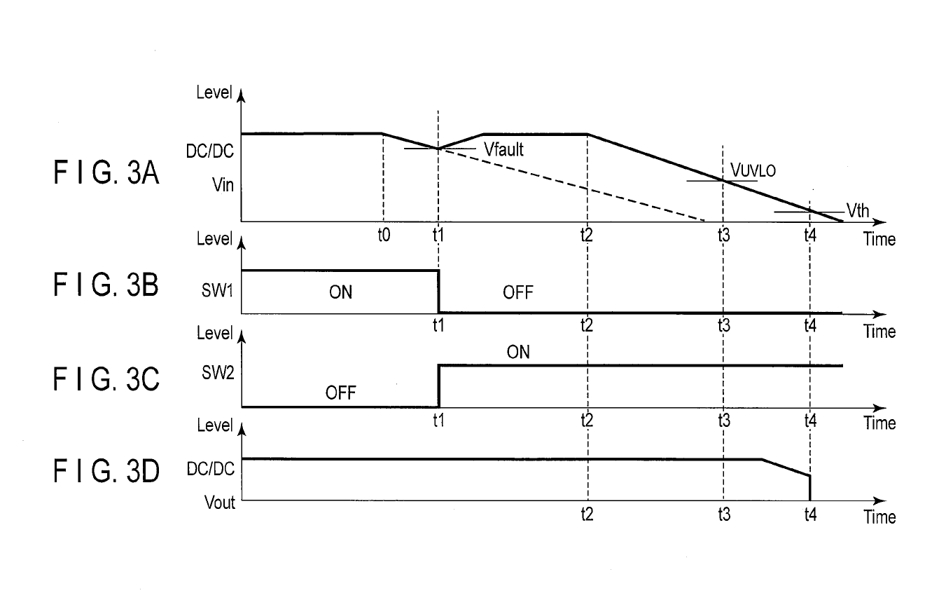

Next, referring to FIG. 3A to FIG. 3C, the operation of the circuit illustrated in FIG. 1 is described in greater detail.

As illustrated in FIG. 1, the input voltage Vin from the external main power supply 6 is monitored by the power monitor 20 which is composed of a voltage detector. As illustrated in FIG. 3A, if a power fault occurs in the main power supply 6 at a certain timing t0, and then the voltage and current from the main power supply 6 suddenly decrease or voltage shutoff (power supply abnormality) of the main power supply 6 occurs, the power monitor 20 determines that the main power supply 6 is in a fault mode. For example, in a case where the input current Iin supplied from the main power supply 6 decreases and the input voltage Vin suddenly falls to a certain threshold voltage Vfault or less at a certain timing t1 and there is a possibility that the DC/DC converter 2 cannot be operated thereafter, the power monitor 20 determines that the main power supply 6 is in the fault mode, by detecting the sudden decrease to the threshold voltage Vfault. In this fault mode, as illustrated in FIG. 3B and FIG. 3C, an OFF switching signal and an ON switching signal are output to the first and second switches 14 and 18, respectively, and the second switch 18 is turned on at a timing t1 and the first switch 14 is turned off at the same time. By the turn-off of the first switch 14, the supply of the input voltage Vin and input current Iin from the external main power supply 6 is shut off, and the supply of the auxiliary input voltage Vin and auxiliary input current Iin from the backup power supply 16 in accordance with the turn-on of the second switch 18 is started. As illustrated in FIG. 3A, from a timing t1 to a certain timing t2, the auxiliary input voltage Vin is kept substantially constant, and this substantially constant auxiliary input voltage Vin is converted by the DC/DC converter 2, and, as shown in FIG. 3D, a fixed output voltage is output from the DC/DC converter 2.

The DC/DC converter 2 includes the UVLO function and current limiting function, as described above. However, after the switching to the backup power supply 16, the processor 22 shuts off unnecessary circuits and outputs to the DC/DC converter 2 a disable instruction to disable the UVLO function and current limiting function. Accordingly, after the switching to the backup power supply 16, the UVLO function and current limiting function of the DC/DC converter 2 are disabled. Specifically, after a certain timing t2 at which the switching to the backup power supply 16 has been effected, the auxiliary input voltage Vin and auxiliary input current Iin from the backup power supply 16 begin to decrease. Thereafter, at a certain timing t3, the auxiliary input voltage Vin and auxiliary input current Iin lower to the threshold Vuvlo at which the UVLO function provided in the DC/DC converter 2 functions. However, since the UVLO function and current limiting function are disabled by the disable instruction, an output corresponding to the lowered auxiliary input voltage Vin and auxiliary input current Iin continues to be output from the DC/DC converter 2, even after the timing t3, as illustrated in FIG. 3D.

Even after the auxiliary input voltage Vin and auxiliary input current Iin from the backup power supply 16 have begun to decrease, the switching operation in the DC/DC converter 2 is continued in accordance with the input voltage Vin and current Iin, and the output from the DC/DC converter 2 is kept until a timing t4. The timing t4 corresponds to a timing at which the auxiliary input voltage Vin from the backup power supply 16 lowers to an operation limit voltage value Vth of the DC/DC converter 2, and the operation of the DC/DC converter 2 is stopped at the timing t4.

As has been described above, when the main power supply 6 is in the fault mode, in the HDD, the auxiliary input voltage Vin and auxiliary input current Iin from the backup power supply 16 are supplied and the output from the DC/DC converter 2 is maintained. Thus, the data saved in the buffer memory or the like can be stored in a NAND flash memory, and data loss based on power supply shutoff, etc. can be prevented.

In the fault mode, from the timing t0 to timing t4, the processor 22 executes a process of storing the data, which is saved in the buffer memory or the like, into the NAND flash memory or the like. Thereafter, if the first switch 14 is rendered ON and the second switch 18 is rendered OFF, as in the initial state, and the input voltage Vin from the main power supply 6 is restored to exceed the certain threshold Vfault, restoration occurs from the fault mode to the normal mode. Specifically, after the completion of data storage into the NAND flash memory, the first switch 14 is rendered ON and the supply of the input voltage Vin and input current Iin from the external main power supply 6 is resumed, and at the same time the second switch 18 is rendered OFF and the supply of the auxiliary input voltage Vin and auxiliary input current Iin is stopped. Then, by the power from the external main power supply 6, DC/DC conversion in the DC/DC converter 2 is executed.

As has been described above, in the circuit illustrated in FIG. 1, in the fault mode, there is no fear that such over-current as to damage the DC/DC converter 2 is supplied from the backup power supply 16 to the DC/DC converter 2. Thus, the UVLO function and current limiting function can be disabled. As a result, the auxiliary input voltage Vin and auxiliary input current Iin from the backup power supply 16 can effectively be used.

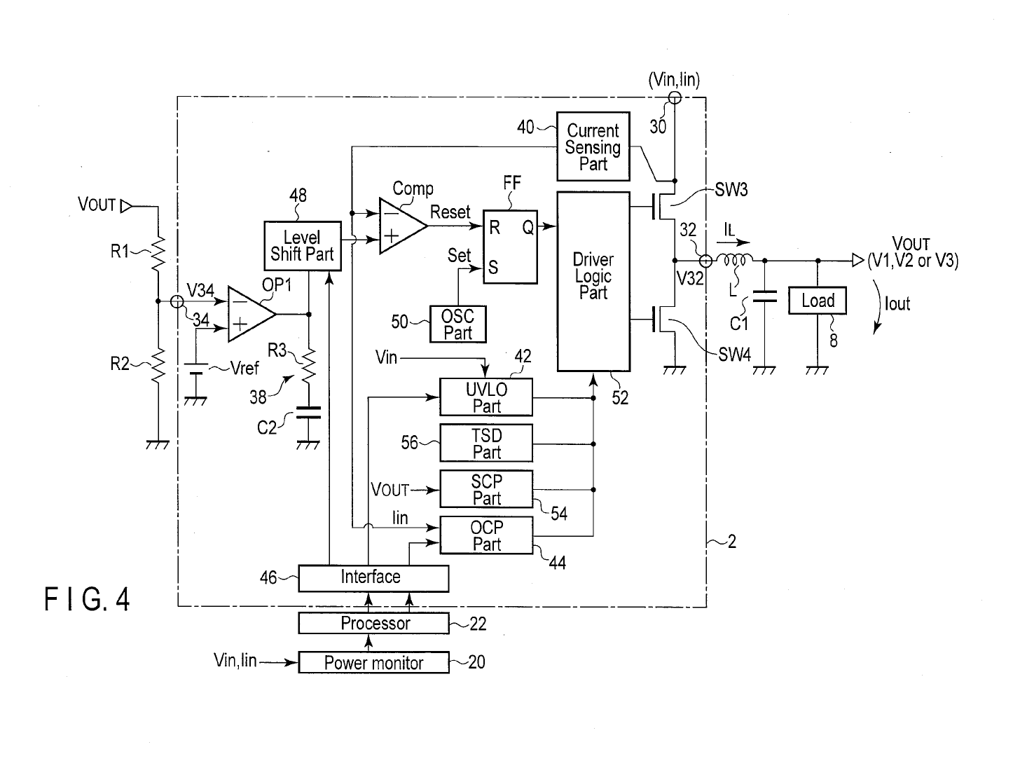

FIG. 4 illustrates an embodiment of the circuit configuration of the DC/DC converter 2 shown in FIG. 1. This DC/DC converter 2 includes a power supply-side terminal 30 which is connected to the main power supply 6 and backup power supply 16, and a series circuit of switching elements SW3 and SW4, which are driven by a driver logic part 52, is connected between the terminal 30 and a ground. A connection node between the switching elements SW3 and SW4 is connected to a terminal 32. A circuit composed of a series circuit of an inductor L and a capacitor C1 is connected between this terminal 32 and the ground. An output voltage Vout is output from a connection node between the inductor L and capacitor C, and this output voltage Vout is applied to the load 8. Then, this output voltage Vout is applied to a series circuit of resistors R1 and R2 which are series-connected and grounded. In order to keep the output voltage Vout constant, a voltage V34, which is divided by the resistors R1 and R2, is applied to a terminal 34 which is connected to a connection node between the resistors R1 and R2, and the output voltage Vout is voltage-fed back to the DC/DC converter 2. In addition, a current flowing in the drain of the switching element SW3 is detected by a current sensing part 40, and a detection signal is output from the current sensing part 40 to a comparator Comp.

The terminal 34 is connected to an inversion input of an operational amplifier OP of the DC/DC converter 2, and is compared with a reference voltage Vref supplied to a non-inversion input of the operational amplifier OP. In this case, the voltage V34, which is divided by the resistors R1 and R2, is determined on a circuit-by-circuit basis in accordance with a target output voltage (V1 to Vn) which is applied to the load 8. An output of the operational amplifier OP is grounded via a filter circuit 38 which is composed of a series circuit of a resistor R3 and a capacitor C2, and is supplied to a level shift part 48. A target value signal from the level shift part 48 is delivered to an inversion input of the comparator Comp. A current detection signal having a correlation to the input current Iin is supplied to a non-inversion input of the comparator Comp. Accordingly, in the comparator Comp, the target value signal and the current detection signal are compared, and if the current detection signal exceeds the target value signal, an ON signal is input as a reset signal to a reset terminal R of a flip-flop FF.

A pulse signal is input from an oscillation part (OSC part) 50 to a set terminal S of the flip-flop FF. Then, the flip-flop FF is set at fixed cycles, and a set output is output from the flip-flop FF to the driver logic part 52. In accordance with the set output, PWM control signals are supplied from the driver logic part 52 to the switching elements SW3 and SW4, and the switching elements SW3 and SW4 are alternately turned on/off. In accordance with the ON/OFF of the switching elements SW3 and SW4, unless there is abnormality in the input power from the main power supply 6, the supplied DC input voltage is converted to a DC voltage, and the DC voltage is supplied to the load 8.

The circuit shown in FIG. 4 includes a UVLO part 42 having a UVLO function for protecting the converter 2, and an OCP part 44 having an OCP function for protecting the converter 2 against the supply of over-current from the main power supply 6. If the input voltage Vin, which is supplied from the main power supply 6, lowers to a certain threshold VUVLO or less, and the input current Iin is increased, the UVLO part 42 determines that supply current abnormality occurs in the DC/DC converter 2, and outputs a signal for stopping the circuit operation to the driver logic 52. In addition, if the input current Iin, which is supplied from the main power supply 6, is abnormally increased and exceeds the threshold current value, the OCP part 44 outputs a signal for stopping the circuit operation to the driver logic 52. In response to the stop signal, the driver logic 52 stops the operation of the circuit of the DC/DC converter 2, so that no switching signal may be output to the switching elements SW3 and SW4. In addition, the circuit shown in FIG. 4 includes a TSD (Thermal Shut Down) part 56 which detects the temperature of a module constituting the converter 2 when the temperature of the module has risen to a predetermined temperature or above during the operation of the module, and outputs a signal for stopping the circuit operation to the driving logic 52. Furthermore, this circuit 2 includes an SCP (Short Circuit Protection) part 54 which detects short-circuit in the DC/DC converter 2 from abnormality of the output voltage Vout, and outputs a signal for stopping the circuit operation to the driver logic 52.

Specifically, the DC/DC converter 2 is protected by the UVLO part 42, OCP part 44, TSD part 56 and SCP part 54. However, as has already been described, in the voltage supply circuit shown in FIG. 1, if power supply shutoff from the main power supply 6 or a sudden power decrease occurs and the PLP function operates, the processor 22 outputs the disable signal for disabling the operations of the UVLO part 42 and OCP part 44, and temporarily disables the functions of these UVLO part 42 and OCP part 44.

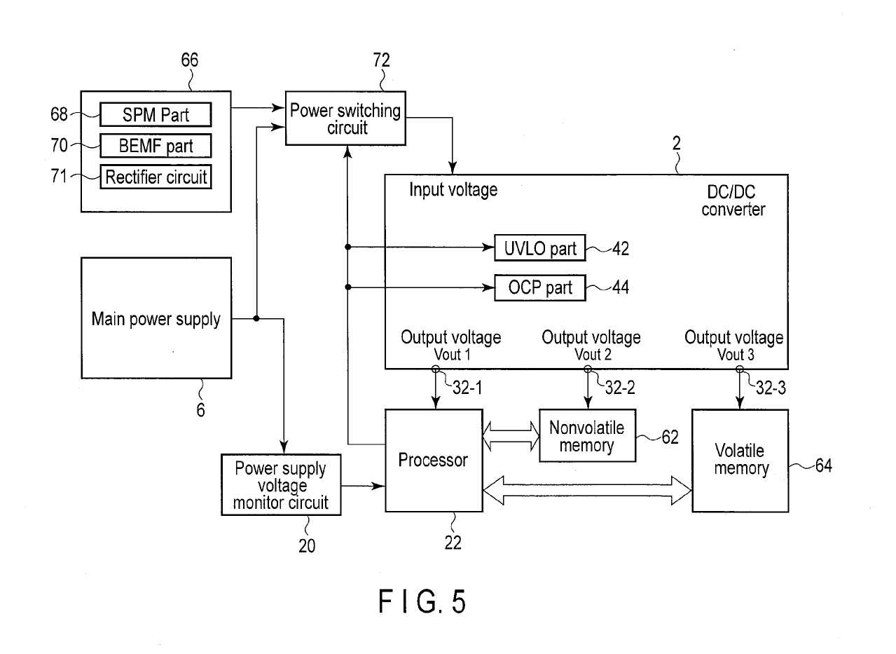

Next, referring to FIG. 5, a description is given of a disk apparatus as an example of a data storage apparatus including the DC/DC converter 2. FIG. 5 illustrates circuit blocks of a disk apparatus (hard disk drive (HDD)) including the DC/DC converter 2 shown in FIG. 1 and FIG. 4. This DC/DC converter 2 includes the UVLO part 42 and OCP part 44 described above, and converts the input voltage, which is input to the input terminal, to first, second and third output voltages Vout1, Vout2 and Vout3 and supplies them to the processor 22, a nonvolatile memory 62 and a volatile memory 64. In order to output the first, second and third output voltages Vout1, Vout2 and Vout3, the DC/DC converter 2 shown in FIG. 5 includes three terminals 32-1, 32-2 and 32-3, and the switching elements SW3 and SW4 are connected to each of these terminals 32-1, 32-2 and 32-3. The switching elements SW3 and SW4 are operated with different settings.

A disk part shown in FIG. 5 is composed of a spindle motor (SPM) part 68 which rotates disk media, a back electromotive force part (BEMF part: Back Electromotive Force part) 70, and a rectifier circuit 71. In the BEMF part 70, when a spindle motor is stopped after evacuating a magnetic head, a back electromotive force generated by the spindle motor part 68 is recovered, and the recovered power is rectified by the rectifier circuit 71 and generated as backup power. The backup power from the BEMF part 70 is supplied to a power switching circuit 72 including the switch SW1 and switch SW2. In the power switching circuit 72, either the main power or the backup power is selected in accordance with an instruction of the processor 22, and is input as an input voltage to the input terminal of the DC/DC converter 2. The power supply voltage of the main power supply 6 is monitored by the power supply voltage monitor (power monitor) 20, and the monitored power supply voltage is supplied as a monitoring signal to the processor 22.

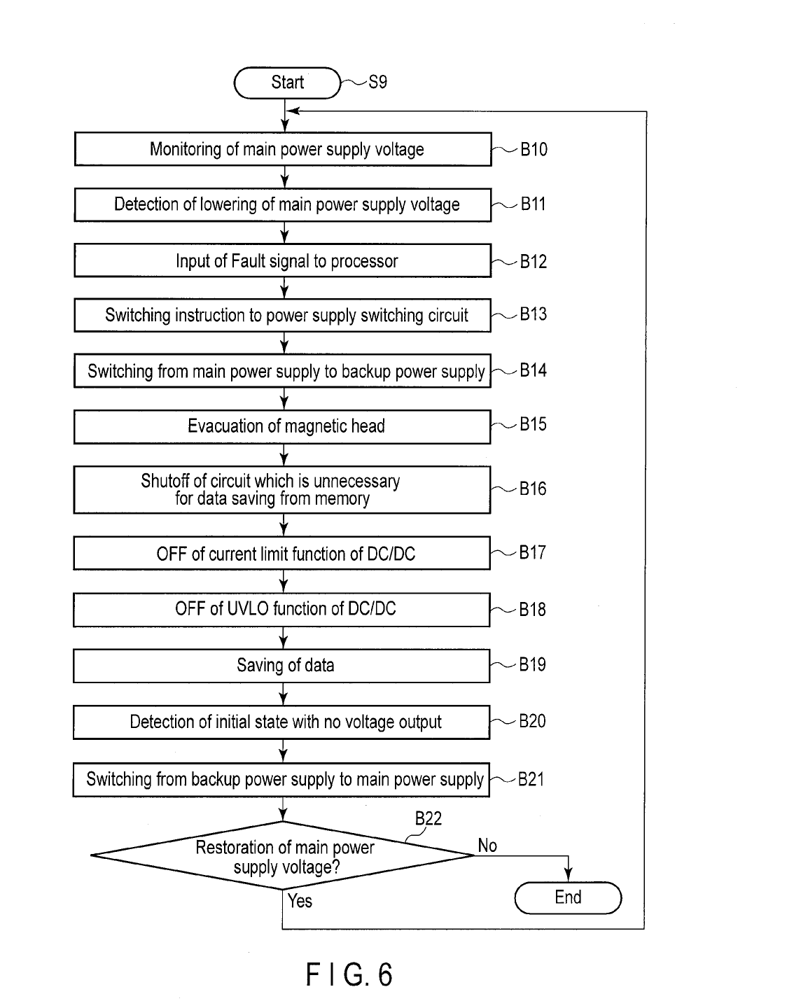

In accordance with the monitoring signal from the supply power monitor 20, the processor 22 is operated as illustrated in blocks shown in FIG. 6.

The following process may be configured as functional blocks by the processor 22.

As illustrated in FIG. 6, in block B9, in an initial state, which is a state (default state) in which the switch SW1 in a normal mode state is turned on, if power supply from the main power supply 6 is started, the internal circuit of the DC/DC converter 2 is kept in a quasi-standby state until the input voltage (Vin) from the main power supply 6 to the DC/DC converter 2 reaches a UVLO release voltage. If the input voltage (Vin) reaches the UVLO release voltage, the UVLO part 42, OCP part 44, TSD part 56 and SCP part 54 of the DC/DC converter 2 start to operate. Accordingly, the DC/DC converter 2 operates, the power from the main power supply 6 is DC/DC converted, and the DC voltage Vout and current Iout are supplied to the load 8. In the state in which the DC voltage Vout and current Iout are being supplied, the power monitor 20 monitors the main power supply voltage, as indicated in block B10.

If the supply power from the main power supply 6 lowers, the power monitor 20 detects a decrease in supply power, in particular, a decrease in power supply voltage Vin, as indicated in block B11. As shown in block B12, in response to this detection, a fault (Fault) signal indicating that the power supply voltage Vin has abnormally lowered is generated in the power monitor 20, and the fault signal is input to the processor 22. Responding to this fault (Fault) signal, the processor 22 instructs power supply switching to the power supply switching circuit 72 which is composed of the switching elements SW1 and SW2, as indicated in block B13. This power supply switching circuit 72 may be switched, not by the instruction from the processor 22, but by a signal from a switching signal generator (not shown) which responds to the fault (Fault) signal. Next, as indicated in block B14, the power supply switching circuit 72 switches the supply source of power from the main power supply 6 to the backup power supply 16. As indicated in block B15, in accordance with the switching of the power supply, the processor 22 executes an unload operation of the magnetic head (not shown) and evacuates the magnetic head to the ramp. In addition, as indicated in block B16, the processor 22 shuts off power supply to a circuit which is not necessary for data saving from the memory, and decreases the output current from the DC/DC converter 2. Further, the processor 22 turns off the current limiting function of the OCP part 44, as indicated in block B17, and the processor 22 turns off the UVLO function of the UVLO part 42, as indicated in block B18. Thereafter, as indicated in block B19, the processor 22 saves data from the volatile memory into the nonvolatile memory. The processor 22 executes a process of storing the data, which is saved in a buffer memory or the like, into a NAND flash memory or the like, and then stands by for an initial state in which no voltage is output from the backup power supply 16, as indicated in block B20. If the initial state is detected, the switching SW1 is rendered on and the switching SW2 is rendered off and the default state is restored, and switching is effected from the backup power supply to the main power supply. Thereafter, as indicated in block B21, if the input voltage Vin from the main power supply 6 is restored to exceed a certain threshold Vfault, restoration occurs to the normal mode in which the power supply voltage is monitored.

As has been described above, in the voltage supply circuit, if power supply shutoff from the main power supply 6 or a sudden power decrease has occurred, the PLP function operates, and switching is effected to the backup power supply, and the current limiting function and UVLO function in the DC/DC converter 2 are rendered off. Thus, power is supplied to the DC/DC converter 2 while the consumption of power from the backup power supply is being suppressed, the period of power supply from the backup power supply can be extended. Therefore, the data, which is stored in a volatile memory or the like, can surely be transferred to a nonvolatile memory by the output from the DC/DC converter 2, and an accidental situation, such as data loss, can be avoided.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A DC/DC converter comprising:
an input terminal to which a main DC power composed of a DC power supply voltage and a DC supply current is supplied from a main power supply, or to which a backup power composed of a backup voltage and a backup current is supplied from a backup power supply;
a converter part configured to convert the DC power supply voltage to a DC conversion voltage and to output the DC conversion voltage, or to convert the backup voltage to a backup conversion voltage and to output the backup conversion voltage;
an output terminal configured to output the DC conversion voltage or the backup conversion voltage to a load; and
a first circuit part including a first stop function for stopping the conversion operation of the DC power supply voltage in the converter part when the DC power supply voltage has lowered to less than a certain threshold voltage, the first circuit part being configured to disable the first stop function in accordance with supply of the backup power, and to cause the converter part to continue the conversion operation of the backup voltage.

2. The DC/DC converter of claim 1, further comprising:
a second circuit part including a second stop function for stopping the conversion operation of the DC power supply voltage in the converter part when the DC supply current exceeds a certain threshold current, the second circuit part being configured to disable the second stop function in accordance with supply of the backup power, and to cause the converter part to continue the conversion operation of the backup voltage.

3. The DC/DC converter of claim 1, further comprising:
a feedback terminal to which the DC conversion voltage or the backup conversion voltage, which is output from the output terminal, is to be fed back; and
a third circuit part configured to operate the converter part, based on the fed-back voltage.

4. The DC/DC converter of claim 1, further comprising:
a detection circuit configured to detect the DC supply current which is supplied to the input terminal, and to output a current detection signal; and
a fourth circuit part configured to operate the converter part, based on the current detection signal.

5. The DC/DC converter of claim 1, wherein the converter part comprises:
a switching element connected to the input terminal; and
a switching circuit configured to output a switching signal which turns on/off the switching element in accordance with the DC conversion voltage or the backup conversion voltage, which is output from the output terminal.

6. The DC/DC converter of claim 5, wherein the first circuit part is configured to stop the switching circuit and to stop the output of the on/off signal.

7. A data storage apparatus comprising:
a monitor part configured to monitor a DC power supply voltage from a main power supply which supplies a main DC power composed of the DC power supply voltage and a DC supply current, to detect a decrease of the DC power supply voltage, and to output a detection signal;
a backup power supply configured to supply a backup power composed of a backup voltage and a backup current;
a switching circuit configured to selectively switch to either the main power supply or the backup power supply, and to supply either the main DC power or the backup power;
a converter part configured to convert the DC power supply voltage to a DC conversion voltage, or to convert the backup voltage to a backup conversion voltage;
a first circuit part including a first stop function for stopping the conversion operation of the DC power supply voltage in the converter part when the DC power supply voltage has lowered to less than a certain threshold voltage;
a volatile storage part which is operated by the DC conversion voltage or the backup conversion voltage, and which is configured to temporarily store data;
a nonvolatile storage part which is operated by the DC conversion voltage or the backup conversion voltage, and which is configured to nonvolatilely store data; and
a processor configured to, in response to the detection signal, cause the backup power to be supplied from the switching circuit to the converter part, to operate the volatile storage part and the nonvolatile storage part by the backup conversion voltage from the converter part, to save data from the volatile storage part into the nonvolatile storage part, to disable the first stop function, and to cause the converter part to continue the conversion operation of the backup conversion voltage.

8. The data storage apparatus of claim 7, further comprising:
a spindle motor configured to rotate a disk medium,
wherein the backup power supply is configured to include a back electromotive force part configured to output a back electromotive force which is generated by the spindle motor, and a rectifier circuit configured to rectify the back electromotive force and to output the rectified back electromotive force as the backup power.

9. The data storage apparatus of claim 7, wherein the switching circuit includes:
a first switching part connected between the main power supply and the converter part and turned on during a normal time; and
a second switching part connected between the backup power supply and the converter part and turned off during the normal time,
wherein the first switching part is turned off and the second switching part is turned on in response to the detection signal, thereby supplying the backup power to the converter part from the backup power supply.

10. The data storage apparatus of claim 7, further comprising:
a second circuit part including a second stop function for stopping the conversion operation of the DC power supply voltage in the converter part when the DC supply current exceeds a certain threshold current,
wherein the processor is configured to disable the second stop function in response to the detection signal, and to cause the converter part to continue the conversion operation of the backup conversion voltage.

11. The data storage apparatus of claim 7, wherein the converter part includes:
a switching element connected to the switching circuit; and
a switching circuit configured to output a switching signal which turns on/off the switching element in accordance with the DC conversion voltage or the backup conversion voltage.

12. A method of controlling a data storage apparatus which comprises a DC/DC converter including a function for stopping a conversion operation of a DC power supply voltage from a main power supply when the DC power supply voltage has lowered to less than a certain threshold voltage, the method comprising:
causing the DC/DC converter to convert the DC power supply voltage to a DC conversion voltage;
detecting a decrease of the DC power supply voltage, switching from the main power supply to a backup power supply, and causing the DC/DC converter to convert a backup voltage from the backup power supply to a backup conversion voltage;
operating, by the backup voltage, a volatile storage part configured to temporarily store data and a nonvolatile storage part configured to nonvolatilely store data, and saving data from the volatile storage part into the nonvolatile storage part; and
disabling a first stop function in response to the detection of the decrease of the DC power supply voltage, and causing the DC/DC converter to continue the conversion operation of the backup voltage.

13. The method of controlling of claim 12, wherein the data storage apparatus comprises a spindle motor configured to rotate a disk medium, and
the backup power supply is configured to include a back electromotive force part configured to output a back electromotive force which is generated by the spindle motor, and a rectifier circuit configured to rectify the back electromotive force and to output the rectified back electromotive force as the backup power.

14. The method of controlling of claim 12, wherein the data storage apparatus includes a switching circuit comprising:
a first switching part connected between the main power supply and the converter part and turned on during a normal time; and
a second switching part connected between the backup power supply and the converter part and turned off during the normal time, and
the first switching part is turned off and the second switching part is turned on in response to the detection signal, thereby supplying the backup voltage to the converter part from the backup power supply.

15. The method of controlling of claim 12, wherein the DC/DC converter includes a second stop function for stopping the conversion operation of the DC power supply voltage in the converter part when a DC supply current to the DC/DC converter exceeds a certain threshold current, and
the processor is configured to disable the second stop function in response to the detection signal, and to cause the converter part to continue the conversion operation of the backup conversion voltage.
